(19) United States
(12) Patent Application Publication
(10) Pub. No.: US 2007/0244711 A1
(43) Pub. Date: Oct. 18, 2007

(54) Safety notification system via web based internet site

(76) Inventors: Edward Francis Rose, Guilford, CT (US); Dena Marie Kist, Greene, RI (US); Alison Louise Shaheen, Branford, CT (US)

Correspondence Address: Dena Marie Kist, 6005 Flat River Road, Greene, RI, 02827, US

(21) Appl. No.: 11/724,958

(22) Filed: Mar. 16, 2007

Related U.S. Application Data
(60) Provisional application No. 60/786,422, filed on Mar. 27, 2006.

(51) Int. Cl. G06Q 10/00; G06Q 30/00; G07G 1/14

(52) U.S. Cl. 705/1; 705/14

(57) ABSTRACT

The present invention offers a website service for notification to member-specified individuals that the member may or may not be safe. This online membership site appeals to all genders and age groups. The intended purpose of the site is to offer individual members a tool to aid in safer dating, meetings, or encounters. Safety features are built into the site which can be customized for each individual based upon the amount of time desired for the date or meeting and a set time to check back into the website signifying they are safe which will then stop the automatic notification process. The notification system retains personal information about the member as well as what the member has entered into the database in regard to their date, meeting or encounter. In the event the member does not terminate the timer, notifications are made to the members predetermined contacts.

### RELATED APPLICATIONS

This application claims priority of Provisional Application No. 60/786,422, filed Mar. 27, 2006.

### BACKGROUND AND SUMMARY OF THE INVENTION

Today, people utilize online dating services to meet people. The meeting of a stranger brings fear and apprehension to many people due to safety factors. Often, careers take people into meetings and places with strangers as well. There is a growing need for people to feel safe during these encounters. The website service will provide various levels of notification should a person not return by a specified time from one of these encounters.

The primary objective is to offer a notification process for people dating, via a web-based system, that alerts predetermined contacts that the member has not logged back into the website and may not be safe.

A secondary objective is to offer the same process identified above in [0003] to college students as well as career people such as home health care workers, real estate agents, and closing agents, etc, where such careers would bring them to unfamiliar environments and meetings with strangers.

To achieve these objectives, interested parties will register on the website. Members will develop a member profile by choosing a user name and password and entering personal data applicable to that member such as age, sex, DOB, height, hair and eye color, visible body markings, etc. Primary and Secondary Contact information will also be entered, identifying sources to contact and how each contact will be made.

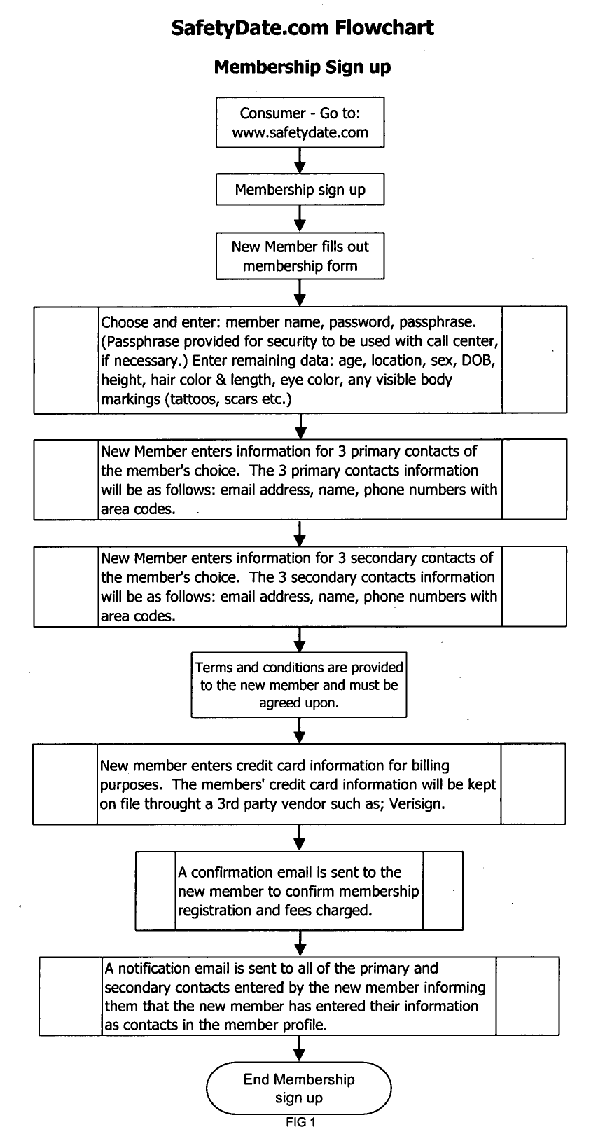

FIG. 1 shows a flowchart of the membership signup.

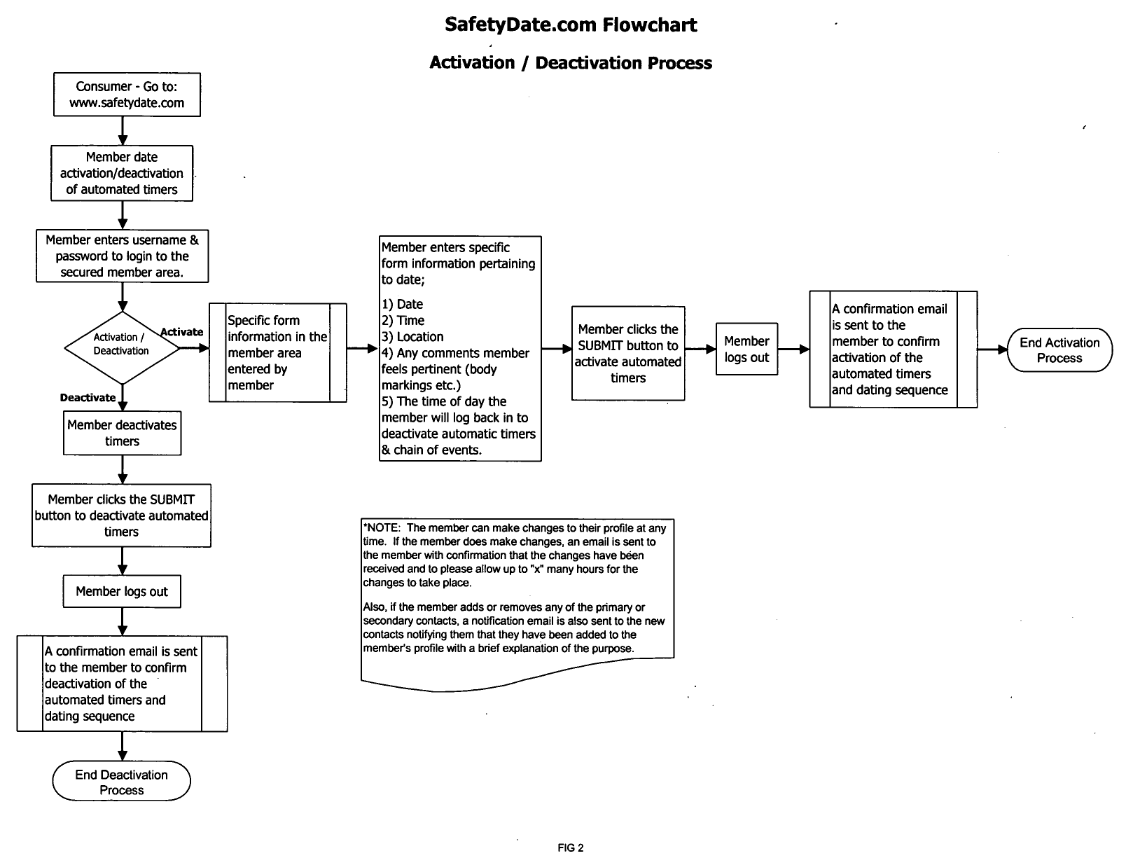

FIG. 2 shows a flowchart of the activation and deactivation process when the member sets a timer.

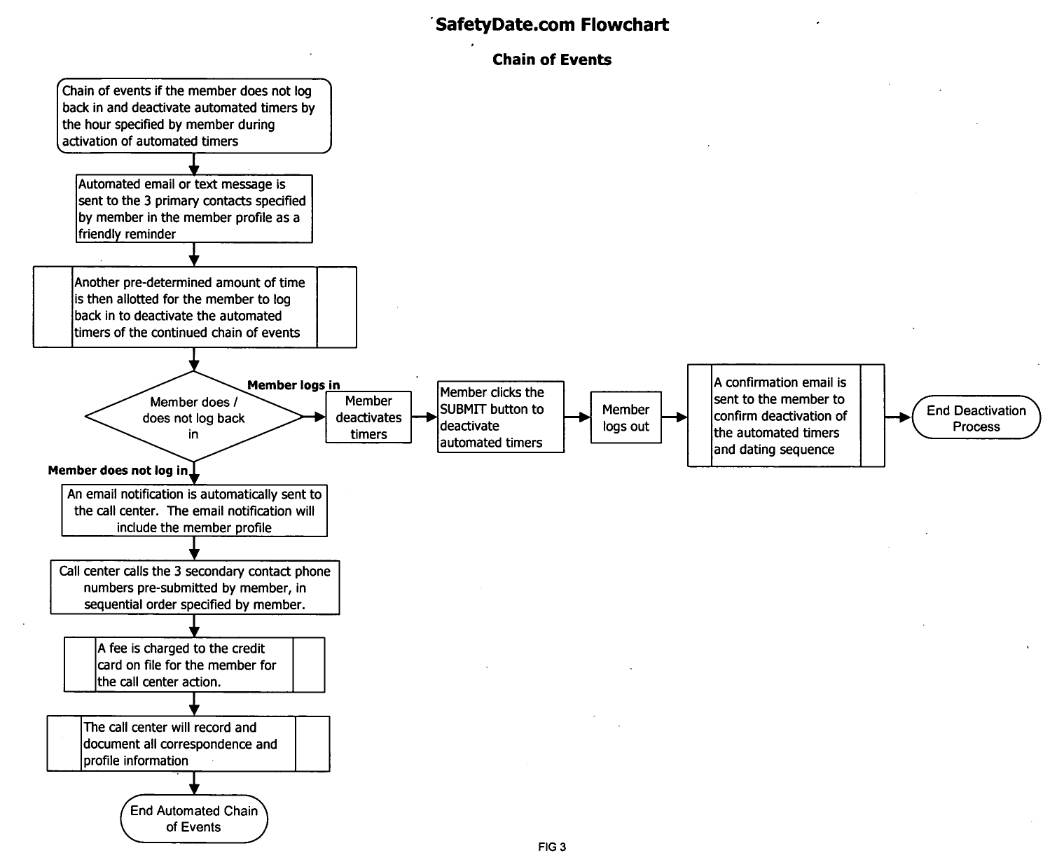

FIG. 3 shows a flowchart of the chain of events in the event the member does or does not deactivate the timer signifying they are safe.

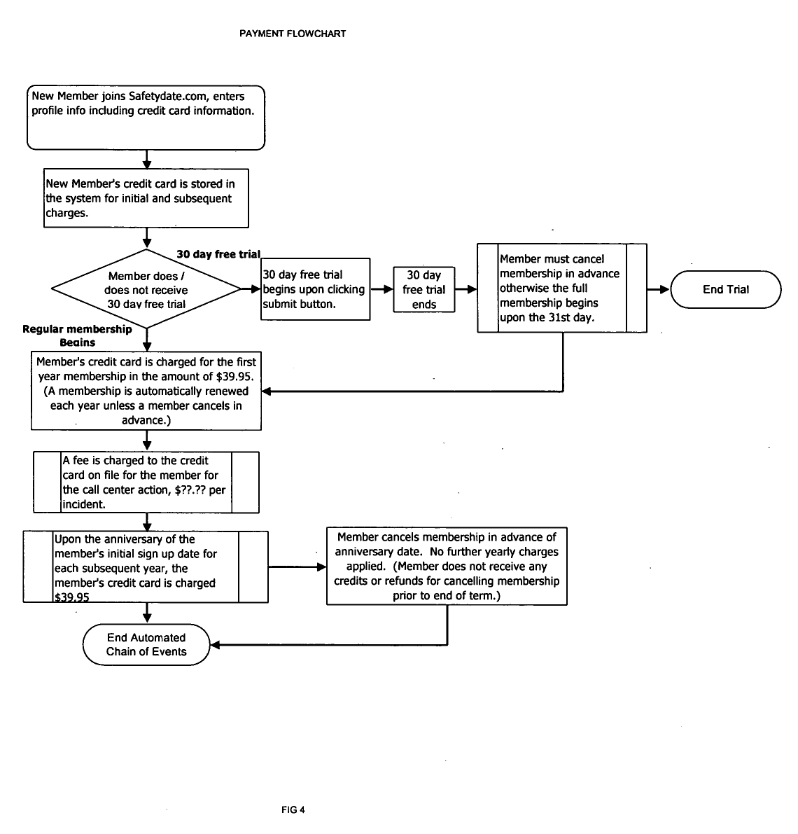

FIG. 4 shows the payment process.

### DESCRIPTION OF THE PREFERRED EMBODIMENTS

This online membership site appeals to all genders and age groups. The intended purpose of the site is to offer individual members a tool to aid in safer dating, meetings, or encounters. Safety features are built into the site which can be customized for each individual based upon the amount of time desired for the date or meeting and a set time to check back into the website signifying they are safe which will then stop the automatic timers. Some of the fields in each member area will include: comments section, name of the person(s) the member is meeting, location of the date or meeting, and any contact information about the person(s) the member is meeting. If the member does not log back in within the amount of time specified and deactivate the timer, a chain of events will begin to take place, whereby notification will be made to the persons previously identified by the member.

Three Primary predetermined email addresses, instant messaging addresses, or cellular numbers, to allow contact by email, phone, text messaging, SMS or instant messaging, are specified by the member at the time of registration and may be modified by the member thereafter. If the member does not log in to the website at the time specified, automatic notifications will be sent to the three contacts using the predetermined methods specified as a friendly reminder that the member has not logged back in from the date or meeting.

Another predetermined amount of time is then allotted for the member to log back into the website to stop the automatic timers.

If again, the member does not log back into the website within the specified time, a notification, including the member's profile, will be sent to a call center.

The call center will then, using the Secondary contacts, call, email, SMS, text, or by other specified means, notify the members three predetermined secondary points of contact that the member has not logged back into the website signifying they are safe and that they may be in need of assistance. The call center will record and document all correspondence and profile information. This information may be provided to law enforcement authorities as well.

What is claimed is:

1. A website service method for notification to member-specified individuals that the member has not returned from their date, meeting or encounter and may be in need of assistance whereby member has (a) registered in the website and provided personal data, (b) set a timer for the date, meeting or encounter, (c) does not deactivate the timer at the specified time provided by the member, and (d) if timer is not deactivated, notifications are sent to members pre-identified contacts.

2. The method of claim 1 wherein at registration, personal data includes members DOB, age, height, weight, eye color, hair color and length, gender, body markings, and anything that is a unique personal feature of the member.

3. The method of claim 1 wherein when member enters contact information, confirmation is sent to those identified contacts notifying them they have been selected as a contact for said member.

4. The method of claim 1 wherein member sets a timer on the website signifying when they will leave and when they will return and a confirmation is sent to the member.

5. The method of claim 1 wherein when member sets a timer, member includes data on who they are meeting, the place or location where they are meeting, how they are getting to the place or location, the time of the meeting as well as upload pictures of person(s) they are meeting and include other pertinent data in regard to the person(s) they are meeting such as their telephone number(s), email address, screen name or website that member has interacted with the person(s).

6. The method of claim 1 wherein member may terminate the timer via signing into the website with their member ID and Password or member may terminate via telephone, text messaging or SMS.

7. The method of claim 1 wherein if member fails to terminate the timer, notification is sent to the members predetermined primary and secondary contacts within a time specified by the website via email, text messaging, SMS or via telephone calls.

8. The method of claim 1 wherein information entered by member about date, meeting or encounter is given to the contacts, and if determined necessary to law enforcement, to aid in confirming the member is safe or in need of assistance.
